(19) United States
(12) Patent Application Publication
(10) Pub. No.: US 2008/0264901 A1
(43) Pub. Date: Oct. 30, 2008

(54) Chemical Mechanical Polishing Process for Planarizing Copper Surface

(75) Inventors: Xuan Zhu, Shanghai (CN); Mengfeng Tsai, Shanghai (CN)

Correspondence Address: SQUIRE, SANDERS & DEMPSEY L.L.P., 1 MARITIME PLAZA, SUITE 300, SAN FRANCISCO, CA, 94111, US

(73) Assignee: Semiconductor Manufacturing International (Shanghai) Corporation, Shanghai (CN)

(21) Appl. No.: 12/103,400

(22) Filed: Apr. 15, 2008

(30) Foreign Application Priority Data
Apr. 24, 2007 (CN) 200710039877.1

(51) Int. Cl. B44C 1/22

(52) U.S. Cl. 216/38

(57) ABSTRACT

Disclosed is a chemical mechanical polishing planarization method for copper surface, including the following steps: depositing a dielectric layer on the copper surface, and polishing the copper surface having the dielectric layer thereon. The method for planarizing a copper surface by chemical mechanical polishing process according to the present invention can achieve the planarization of the surfaces of both the copper and the dielectric layer, so as to avoid the occurrence of the dishing phenomenon.

### FIELD OF THE INVENTION

The present invention generally relates to the technical field of semiconductor manufacture, and more particularly, to a chemical mechanical polishing (CMP) process for planarizing copper damascene surface.

### DESCRIPTION OF THE RELATED ART

With the rapid development of semiconductor manufacturing technology, the critical dimension (CD) of semiconductor device has reached a deep-submicron level. It is required to reduce the time-delay caused by impedance, in order to increase the operating rate of a chip. Accordingly, most of the dielectrics used in a semiconductor device have a low dielectric constant and copper metal is widely used as an interconnection material, in order to reduce the resistance of the metal wire. The interconnection structure is typically formed by a damascene process, that is, by etching one or more dielectric layers on the substrate to form the via or trench and then depositing metal into the via or trench. Although the resistance of copper is lower than that of aluminium (Al) or tungsten (W), copper is liable to diffuse into the dielectric layer due to its higher diffusion coefficient, and thus a material such as tantalum (Ta), tantalum nitride (TaN), titanium (Ti), or titanium nitride (TiN) generally is deposited on the sidewalls and bottom of the via or trench as a diffusion barrier layer prior to the deposition of copper. An important index in the above damascene process is the planarization of the metal layer and diffusion barrier layer, that is, it is important to have the surfaces of both the metal layer and thedielectric layer disposed on the same plane.

Chemical Mechanical Polish (CMP) process is a key technology of overall planarization in the current advanced semiconductor manufacture, in which the mechanical polishing action and chemical etching action of a slurry is utilized. In the prior semiconductor manufacturing technology, a semiconductor structure is generally planarized by using CMP process to reduce the height difference between surfaces of the semiconductor structure. When copper is planarized or both copper and surrounding dielectric material thereof are polished simultaneously, the factors that influence the planarization effect include the removal rate of copper and the removal rate of the surrounding dielectric material thereof. If the softer copper surface is polished at a faster removal rate, a dishing phenomenon will occurr on the copper surface due to the over-polishing. FIG. 1 and FIG. 2 are schematic views for illustrating the dishing phenomenon. As shown in FIG. 1, a narrow trench 120 and a wide-width trench 110 are formed in a dielectric layer 100 by etching, in order to form a connecting structure with a specific function. The narrow trench 120 and the wide-width trench 110 generally have a large difference in width, and trench 120 are generally distributed in a relatively dense region. Accordingly, after the deposition of metal copper 200, a bump 210 is formed on the surface of metal copper over the dense region, and a recess 220 is formed on the surface of metal copper over the wide-width trench 110, so that a height difference is formed on the device surface. When performing the planarization by CMP process, the removal rate of metal copper is generally higher than that of the dielectric layer 100, so that the metal copper 200 will be polished at a higher removal rate. At the same time, since the bump 210 and the recess 220 of the metal copper surface have the same removal rate, dishings 230 and 240 occur on the copper surface filled in the dense region and the wide trench.

Chinese patent application No. 02123365.9 discloses a method for reducing dishing in CMP process for copper, in which the slurry used comprises a reactive reagent for forming metallide. The metal layer is reacted with the reactive reagent in the slurry and then a metallide layer is formed on the surface of the metal layer to protect the metal layer from being polished at a higher removal rate. However, this method requires a specific slurry in which the reagents such as potassium iodate, hydrogen peroxide, ferric nitride, or ammonium persulfate, etc. should be added, which of course increases the manufacturing costs and the process complexity. Therefore, there is a need for a method with low cost and simple process to eliminate the above-mentioned dishing phenomenon.

### SUMMARY OF THE INVENTION

An object of the present invention is to provide a CMP process for planarizing copper surface, which can effectively eliminate the dishing phenomenon after the planarzation of the surface of the copper-coated dielectric layer.

For the purpose, in one aspect, the present invention provides a CMP process for planarizing copper surface, comprising the steps:

depositing a dielectric layer on said copper surface, and

polishing the copper surface on which the dielectric layer is deposited.

The material of the dielectric layer is one of silicon oxide, silicon carbide (SiC), silicon nitride (SiN), silicon carbon oxide (SiCO), silicon carbon nitride (SiCN), fluorosilicate glass (FSG), phosphosilicate glass (PSG), borosilicate glass (BSG), and boro-phosphosilicate glass (BPSG), or the combinations thereof.

The material of the dielectric layer is an organic bottom anti-reflection coating (BARC) material.

The material of the dielectric layer is a silicon-rich polymer.

The dielectric layer has a thickness between 50 Å and 100 Å.

The dielectric layer is formed by using chemical vapor deposition (CVD) process.

The dielectric layer is formed by using spin coating process.

In another aspect, the present invention provides a CMP process for planarizing copper surface, comprising the steps:

depositing a polish barrier layer on said copper surface,

polishing the polish barrier layer and planarizing a bump region of the copper surface,

continuing the polishing process to reduce the height difference between the bump region and a recess region of the copper surface, and

continuing the polishing process to planarize the copper surface.

The material of the dielectric layer is one of silicon oxide, SiC, SiN, SiCO, SiCN, fluorosilicate glass (FSG), phosphosilicate glass (PSG), borosilicate glass (BSG), and boro-phosphosilicate glass (BPSG), or the combinations thereof.

The material of the polish barrier layer is an organic bottom anti-reflection coating (BARC) material.

The material of the polish barrier layer is a silicon-riched polymer.

The polish barrier layer has a thickness between 50 Å and 100 Å.

The polish barrier layer is formed by using chemical vapor deposition (CVD) process.

The polish barrier layer is formed by using spin-on coating process.

As compared with the prior art, the present invention may possess the following advantages.

In some embodiments of the present invention, prior to the polishing process, a dielectric layer is deposited on a metal copper surface, which serves as a barrier layer for blocking the polishing progression. At the beginning of polishing, the dielectric layer on the surface of bump region is polished away by the friction between the polish pad and the dielectric layer, and then the exposed copper is removed by the common action of both the slurry and the friction, so that a portion of the bump region of copper surface is planarized. At the recess region, the dielectric material polished away is continuously accumulated on the recess region to thicken the dielectric layer in the recess region, so that the removal rate of the recess region is decreased. With the progress of polishing, the removal rates in and out the recess region of the copper surface tend to be uniform due to the blocking action of the dielectric layer, so as to avoid the occurrence of the dishing phenomenon. In addition, the present method is not required to vary the composition of slurry, has a simple process, and reduces the manufacturing costs.

### BRIEF DESCRIPTION OF THE DRAWINGS

The above and other objects, features and advantages of the present invention will be more apparent through the more detailed description of preferred embodiments of the present invention as illustrated in the drawings below. Like reference numeral refers to similar part in overall drawings. It is not intended to draft the drawings in scale, but tending to show the keynote of the present invention. In the drawings, for sake of clarity, the thicknesses of layers and regions are amplified.

FIG. 1 to FIG. 2 are schematic cross-section views of the device for illustrating the dishing phenomenon; and

FIG. 3 to FIG. 6 are schematic cross-section views of the device for illustrating the preferred embodiments of the present invention.

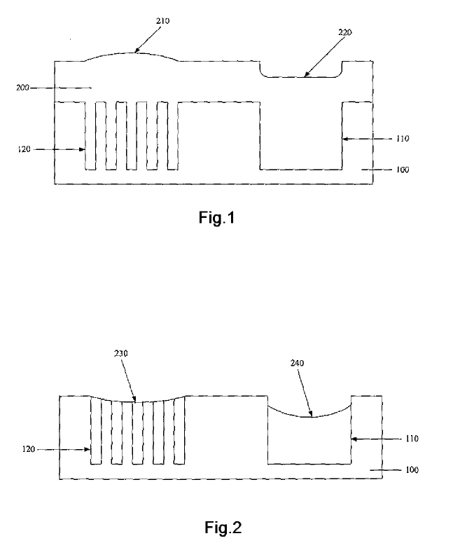

### SPECIFIC EMBODIMENTS OF THE INVENTION

In order to make the above and other objects, features and advantages of the present invention more apparent, the detailed description of the specific embodiments of the present invention will be made below in combine with the appended drawings.

Many specific details have been described in the following description in order to completely understand the present invention. However, the present invention can be performed in other ways different from that described herein; the skilled in the art could readily extend it without departing from the spirit of the present invention. Therefore, the present invention is not limited by the specific examples disclosed below.

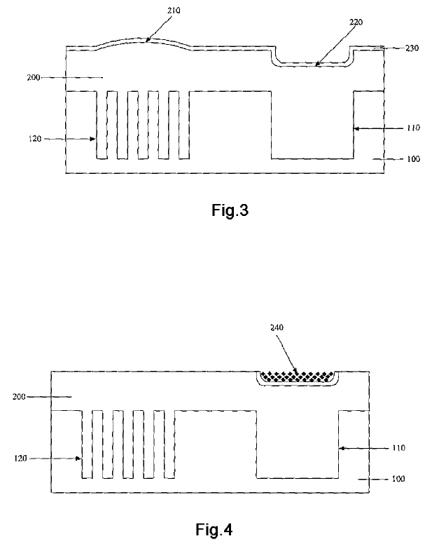

FIG. 3 to FIG. 6 are schematic cross-section views of the device for illustrating the preferred embodiments of the present invention. The schematic views are only examples, which do not intend to limit the scope of the present invention. At first, as shown in FIG. 3, the dielectric layer 100 is an inorganic silicon-based layer with a low dielectric constant deposited by CVD, such as SiCO or FSG, preferably a low-k material with a trade name of Black Diamond of Applied Materials CO. In a preferred embodiment of the present invention, the dielectric layer 100 is formed by a heating sub-atmospheric pressure chemical vapor deposition (SACVD) process using carbon-containing organic metal or an organic silicon compound, ozone and dopant sources. The carbon-containing organic metal or the organic silicon compound may comprise cyclosiloxane, such as tetramethyl cyclotetrasiloxane (TMCTS) or octomethyl cyclotetrasiloxane (OMCTS) or other cyclosiloxane, preferably OMCTS. In a convenient CVD reaction chamber for single crystal wafer, a wafer is placed on a platform within the reaction chamber, and the platform is provided with a heated element, and is controlled by a thermal sensor for controlling the temperature in the reaction chamber. All components of the reaction chamber are maintained at a predetermined temperature. According to the present invention, reactive gas streams are supplied into the reaction chamber, which at least comprise OMCTS, helium, a mixture of oxygen and ozone, wherein the reactive gases are introduced into a pre-mixing chamber and the gas mixture is applied on the wafer. In a preferred example of the present invention, the gases are premixed in a premixing chamber for beginning of the reaction and obtaining a film with desired properties, in order to obtain a desired dielectric constant. Alternatively, the gases can be individually released into the reaction chamber without premixing, but in this case, the gases should be kept away from the wafer surface in a distance, such as approximately 0.05-0.5 inches. However, this alternative way of post-mixing way will obtain a film with a property inferior to the best property. The pressure in the reaction chamber is maintained at predetermined pressure, and the gas mixture is applied onto the wafer for predetermined time, in order to form the dielectric layer 100 with a low dielectric constant.

Next, the dielectric layer 100 is etched by dry etching such as plasma etching process to form a trench 120 and a trench 110. In the reaction chamber, the directivity of etching can be implemented by controlling the radio frequency (RF) power of plasma source and anode (that is, the substrate) bias power. In this example, the etchant gases introduced into the reaction chamber has a flow rate of 50-400 sccm, the substrate temperature is maintained between 20° C. and 90° C., the chamber pressure is 4-80 mTorr, and the RF output power of the plasma source is 50 W-2000 W, the etchant is a gas mixture, which can comprises for example a mixture of SF₆, CHF₃, CF₄, Cl₂, N₂, and O₂, and other inert gases, such as Ar, Ne, He and so on. In this example, the vias 120 are disposed in a relatively dense region, which corresponds to the active region of the substrate having a higher device density. The trench 110 is typically used for an inactive region, other region having a less device density, or power line.

Subsequently, metal copper 200 is deposited by using physical vapor deposition (PVD) process or electroplating process, so that metal copper is filled within the trench 120 and the trench 110, since copper is liable to diffuse into the dielectric layer due to its higher diffusing coefficient, a material such as Ta, TaN, Ti, or TiN typically is deposited as a diffusion barrier layer (no shown) on the sidewalls and bottom of the via prior to depositing metal copper. Since the difference in width between the trench 120 and the trench 110 is relatively great and the vias 120 are disposed in a relatively dense region, after depositing the metal copper 200, a bump 210 is formed on the surface of metal copper over the dense region of the trench 120, and a recess 220 is formed on the surface of metal copper over the trench 110, so that a height difference is formed on the surface of deposited metal copper 200.

According to the present invention, before polishing, a dielectric layer is deposited on the metal copper 200 as a polish barrier layer 230 by using CVD process. The material of the polish barrier layer 230 is one of silicon oxide, SiC, SiN, SiCO, SiCN, fluorosilicate glass (FSG), phosphosilicate glass (PSG), borosilicate glass (BSG), and boro-phosphosilicate glass (BPSG), or the combination thereof In another embodiment of the present invention. The material of the polish barrier layer 230 also can be a silicon-riched polymer (such as, GF320) or an organic bottom anti-reflection coating (BARC) formed by spin coating process. The polish barrier layer 230 has a thickness of 50 Å-100 Å.

The following polishing process can be divided into three stages. Firstly, at the starting polishing stage, a polishing head is in contact with the surface of the wafer, a polishing slurry is added, and a pressure is applied to the surface of the wafer by the polishing head through the polishing slurry. The polish barrier layer 230 is polished away by the friction generated between the polishing head and the wafer, and then the bump portion 210 of the copper surface is polished and planarized. In the subsequental polishing process, the mixture 240 of the slurry and the material of the barrier layer polished away are filled into the recess region 220 of the copper surface, as shown in FIG. 4. Since the slurry and copper in the recess region are isolated by the barrier layer and the mixture 240, the removal rate of the copper within the recess region is reduced.

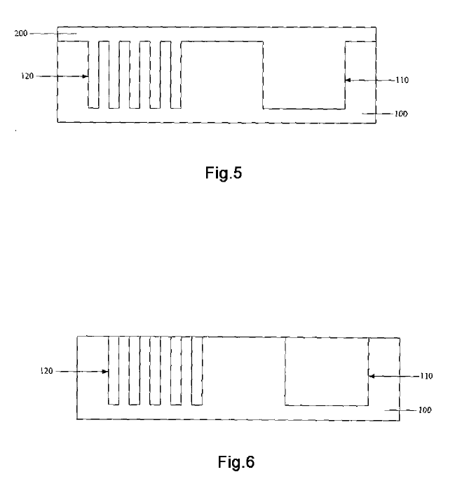

Next, in the middle polishing stage, since the removal rate of the copper out of the recess region 220 is higher than that in the recess region 220, the step height difference of the surface of copper 200 could be reduced. During the polishing process for removing the above mixture 240 and the barrier layer 230, the difference in removal rate of the copper surface 200 in the recess region and out of the recess region becomes smaller and smaller, so that the copper surface tends to be planar, as shown in FIG. 5.

In the final polishing stage, as the polishing process proceeds, the difference in removal rate of the copper surface 200 in the recess region and out of the recess region becomes smaller and smaller, and when the barrier layer of the recess region is contacted with the polishing pad and thus is removed, the removal rate of the copper surface tends to be uniform, so as to avoid the occurrence of the dishing phenomenon and finally achieve the planarization of the surface of copper 200 and the dielectric layer 100, as shown in FIG. 6.

While the present invention has been described with respect to certain preferred embodiments, it will be apparent to those skilled in the art that various changes and modifications may be made without departing from the spirit and scope of the invention as defined in the following claims.

What is claimed is:

1. A chemical mechanical polishing process for planarizing copper surface, which comprising the following steps:
depositing a dielectric layer on the copper surface, and
polishing the copper surface on which the dielectric layer is deposited.

2. The method according to claim 1, wherein the material of the dielectric layer is one of silicon oxide, SiC, SiN, SiCO, SiCN, fluorosilicate glass (FSG), phosphosilicate glass (PSG), borosilicate glass (BSG), and boro-phosphosilicate glass (BPSG), or the combinations thereof.

3. The method according to claim 1, wherein the material of the dielectric layer is an organic bottom anti-reflection coating (BARC).

4. The method according to claim 1, wherein the material of the dielectric layer is a silicon-riched polymer.

5. The method according to claim 2, wherein the dielectric layer has a thickness of 50 Å-100 Å.

6. The method according to claim 3, wherein the dielectric layer has a thickness of 50 Å-100 Å.

7. The method according to claim 4, wherein the dielectric layer has a thickness of 50 Å-100 Å.

8. The method according to claim 2, wherein the dielectric layer is formed by a chemical vapor deposition (CVD) process.

9. The method according to claim 3, wherein the dielectric layer is formed by a spin-on coating process.

10. The method according to claim 4, wherein the dielectric layer is formed by a spin-on coating process.

11. A chemical mechanical polishing process for planarizing copper surface, which comprising the following steps:
depositing a polish barrier layer on the copper surface,
polishing the polish barrier layer and planarizing a bump region of the copper surface,
continuing the polishing process to reduce the height difference between the bump region and a recess region of the copper surface, and
continuing the polishing process to planarize the copper surface.

12. The method according to claim 11, wherein the material of the polish barrier layer is one of silicon oxide, SiC, SiN, SiCO, SiCN, fluorosilicate glass (FSG), phosphosilicate glass (PSG), borosilicate glass (BSG), and boro-phosphosilicate glass (BPSG), or the combinations thereof.

13. The method according to claim 11, wherein the material of the polish barrier layer is an organic bottom anti-reflection coating (BARC).

14. The method according to claim 11, wherein the material of the polish barrier layer is a silicon-rich polymer.

15. The method according to claim 12, wherein the polish barrier layer has a thickness of 50 Å-100 Å.

16. The method according to claim 13, wherein the polish barrier layer has a thickness of 50 Å-100 Å.

17. The method according to claim 14, wherein the polish barrier layer has a thickness of 50 Å-100 Å.

18. The method according to claim 12, wherein the polish barrier layer is formed by a chemical vapor deposition process.

19. The method according to claim 13, wherein the polish barrier layer is formed by a spin coating process.

20. The method according to claim 14, wherein the polish barrier layer is formed by a spin coating process.
